(19) United States
(12) Patent Application Publication
(10) Pub. No.: US 2008/0013512 A1
(43) Pub. Date: Jan. 17, 2008

(54) Wireless Communication System

(76) Inventor: Hiroyuki Yurugi, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/793,009

(22) PCT Filed: Dec. 6, 2005
(86) PCT No.: PCT/JP05/22379

§ 371 Date: Aug. 23, 2007

(30) Foreign Application Priority Data
Dec. 16, 2004 (JP) 2004-364056

(51) Int. Cl. H04Q 7/24; H04N 7/16

(52) U.S. Cl. 370/338; 725/62

(57) ABSTRACT

A video reproduction apparatus 120 wirelessly transmits to a server apparatus 100 estimated reproduction time information TT1 obtained by adding a processing time t1 to time data T1 of video data, and an audio reproduction apparatus 110 wirelessly transmits to the server apparatus 100 estimated reproduction time information TT2 obtained by adding a processing time t2 to time data T2 of audio data. The server apparatus 100 wirelessly receives the estimated reproduction time information TT1 and TT2, and calculates estimated reproduction time difference information Δt thereof to wirelessly transmit. The video reproduction apparatus 120 controls a time for reproducing video data so that video and audio are substantially synchronously reproduced based on the estimated reproduction time difference information Δt, and the audio reproduction apparatus 110 controls a time for reproducing audio data so that video and audio are substantially synchronously reproduced based on the estimated reproduction time difference information Δt.

### TECHNICAL FIELD

The present invention relates to a wireless communication system. More particularly, the present invention relates to a wireless communication system for synchronously reproducing video data and audio data of the same program, and further related to a synchronous reproduction method using the same system.

### BACKGROUND ART

In recent years, accompanying with broadbandization of Internet and spread of various wireless communication systems typified by a wireless LAN, wireless digital electric home appliances, which do not need wiring between the appliances at home and are not restricted to their installation places, have been bringing attention. As an example, there has been proposed a wireless video and audio reproduction system, in which a server apparatus for recording several moving images (of, for example, TV programs or the like), a display for reproducing video, and a loudspeaker for reproducing audio are connected with each other via a wireless network; moving image data is transmitted from the server apparatus; video of video data included in the aforementioned moving image data is reproduced and outputted on the display; and audio of audio data is reproduced and outputted from the loudspeaker.

In the above described wireless video and audio reproduction system, since data to be transmitted and received via the wireless network are digitally coded, some degree of delay time exists between transmission of video data and audio data and reproduction and output the same due to a time required for data decoding, a time required for data transmission via the wireless network, or the like. In this case, a delay time required for video data is different from a delay time required for audio data; and even though the video data and the audio data are transmitted from the server apparatus at the same time, the respective data are not necessarily reproduced and outputted from the display and the loudspeaker at the same time. Any audiences do not care about such reproduction time difference between video data and audio data if the difference is short so as not to be more than approximately 100 milliseconds, however, reproduction time difference more than 100 milliseconds makes the audiences feel any disharmonious impression. Therefore, the reproduction time difference between video and audio due to the delay time difference needs to be reduced and the video so that the audio are synchronously reproduced as much as possible. As a prior art regarding the synchronous reproduction of video and audio using such wireless communication, for example, a radio transceiver system described in Patent Document 1 has been known.

Patent Document 1: Japanese Patent Laid-Open Publication No. JP-2004-193868-A.

### DISCLOSURE OF THE INVENTION

### Problems to be Solved by the Invention

A radio transceiver system disclosed in Patent Document 1 is characterized in that a standard time common to all apparatuses constituting the aforementioned system is provided, a request for time stamp and a response packet are transmitted and received before reproducing a moving image, a delay time required for radio data transmission is measured, and reproduction times of video and audio are determined based on the result. In a case of using such a method, a delay generated by the radio data transmission is absorbed by intentionally delaying video output timing and the reproduction time difference between video and audio can be reduced to have a constant effect; but, there is the following problem at the same time.

(1) In an actual wireless communication system, since a data error rate in a wireless communication path is larger than that in a cable communication path, it is designed that both sides of transceiver apparatuses are provided with sufficient buffer memories so that reproduction of video and audio is not interrupted even when some errors are generated by the wireless communication path. A delay time generated by the buffer memories is not considered.

(2) Although an electric wave environment around the apparatus using the system is not always constant and a radio data transmission time is not also necessarily constant, there is no means for correcting a reproduction time of video or audio as needed depending on a change in the electric wave environment.

An object of the present invention is to solve the foregoing problems and to provide a wireless communication system and a synchronous reproduction method using the same system, capable of performing synchronous reproduction of video data and audio data with precision higher than that of the prior art, and to provided a wireless communication system including a server apparatus for transmitting moving image data, a display for reproducing and outputting video data, and a loudspeaker for reproducing and outputting audio data.

### Means for Solving the Invention

According to the first aspect of the present invention, there is provided a wireless communication system, which includes a server apparatus, a video reproduction apparatus, and an audio reproduction apparatus. The server apparatus wirelessly transmits video data with time data and audio data with time data, respectively, and the video reproduction apparatus wirelessly receives the video data with the time data transmitted wirelessly from the server apparatus, and reproduces and outputs video of the video data. The audio reproduction apparatus wirelessly receives the audio data with the time data transmitted wirelessly from the server apparatus, and reproduces and outputs audio of the audio data. Upon reproducing and outputting the video of the video data, the video reproduction apparatus calculates estimated reproduction time information TT1 by adding a known data processing time t1 required for reproducing and outputting the video data to time data T1 of the video data, and wirelessly transmits the estimated reproduction time information TT1 to the server apparatus. Upon reproducing and outputting the audio of the audio data, the audio reproduction apparatus calculates estimated reproduction time information TT2 by adding a known data processing time t2 required for reproducing and outputting the audio data to time data T2 of the audio data, and wirelessly transmits the estimated reproduction time information TT2 to the server apparatus. The server apparatus wirelessly receives the estimated reproduction time information TT1 from the video reproduction apparatus, wirelessly receives the estimated reproduction time information TT2 from the audio reproduction apparatus, then calculates estimated reproduction time difference information At between the estimated reproduction time information TT1 and the estimated reproduction time information TT2, and wirelessly transmits the estimated reproduction time difference information At to the video reproduction apparatus and the audio reproduction apparatus. The video reproduction apparatus wirelessly receives the estimated reproduction time difference information At from the server apparatus, and then controls a time for reproducing and outputting the video data so that the video of the video data to be reproduced and outputted from the video reproduction apparatus and the audio of the audio data to be reproduced and outputted from the audio reproduction apparatus are substantially synchronously reproduced and outputted based on the estimated reproduction time difference information At received wirelessly. The audio reproduction apparatus wirelessly receives the estimated reproduction time difference information At from the server apparatus, and then controls a time for reproducing and outputting the audio data so that the audio of the audio data to be reproduced and outputted from the audio reproduction apparatus and the video of the video data to be reproduced and outputted from the video reproduction apparatus are substantially synchronously reproduced and outputted based on the estimated reproduction time difference information At received wirelessly.

In addition, in the above-mentioned wireless communication system, the following steps are periodically and repeatedly performed at a predetermined time interval:

(a) calculating and wirelessly transmitting the estimated reproduction time information TT1 and controlling the time for reproducing and outputting the video of the video data based on the estimated reproduction time difference information At received wirelessly, which are performed by the video reproduction apparatus, and

(b) calculating and wirelessly transmitting the estimated reproduction time information TT2 and controlling the time for reproducing and outputting the audio of the audio data based on the estimated reproduction time difference information Δt received wirelessly, which are performed by the audio reproduction apparatus.

Further, in the above-mentioned wireless communication system, the video data is compression-coded video data, the video reproduction apparatus decompression-decodes wirelessly received video data, and the data processing time t1 includes a time required for the decompression-decoding. The audio data is compression-coded audio data, the audio reproduction apparatus decompression-decodes wirelessly received audio data, and the data processing time t2 includes a time required for the decompression-decoding.

According to the second aspect of the present invention, there is provided a synchronous reproduction method using a wireless communication system, which includes a server apparatus, a video reproduction apparatus, and an audio reproduction apparatus. The server apparatus wirelessly transmits video data with time data and audio data with time data, respectively. The video reproduction apparatus wirelessly receives the video data with time data transmitted wirelessly from the server apparatus, and reproduces and outputs video of the video data. The audio reproduction apparatus wirelessly receives the audio data with time data transmitted wirelessly from the server apparatus, and reproduces and outputs audio of the audio data. Upon the video reproduction apparatus's reproducing and outputting the video of the video data, calculating estimated reproduction time information TT1 by adding a known data processing time t1 required for reproducing and outputting the video data to time data T1 of the video data, and wirelessly transmitting the estimated reproduction time information TT1 to the server apparatus. Upon the audio reproduction apparatus's reproducing and outputting the audio of the audio data, calculating estimated reproduction time information TT2 by adding a known data processing time t2 required for reproducing and outputting the audio data to time data T2 of the audio data, and wirelessly transmitting the estimated reproduction time information TT2 to the server apparatus. In the server apparatus, wirelessly receiving the estimated reproduction time information TT1 from the video reproduction apparatus, wirelessly receiving the estimated reproduction time information TT2 from the audio reproduction apparatus, then calculating estimated reproduction time difference information At between the estimated reproduction time information TT1 and the estimated reproduction time information TT2, and wirelessly transmitting the estimated reproduction time difference information At to the video reproduction apparatus and the audio reproduction apparatus. In the video reproduction apparatus, wirelessly receiving the estimated reproduction time difference information At from the server apparatus, and then controlling a time for reproducing and outputting the video data so that the video of the video data to be reproduced and outputted from the video reproduction apparatus and the audio of the audio data to be reproduced and outputted from the audio reproduction apparatus are substantially synchronously reproduced and outputted based on the estimated reproduction time difference information At received wirelessly. In the audio reproduction apparatus, wirelessly receiving the estimated reproduction time difference information Δt from the server apparatus, and then controlling a time for reproducing and outputting the audio data so that the audio of the audio data to be reproduced and outputted from the audio reproduction apparatus and the video of the video data to be reproduced and outputted from the video reproduction apparatus are substantially synchronously reproduced and outputted based on the estimated reproduction time difference information Δt received wirelessly.

In addition, the above-mentioned synchronous reproduction method further includes the following steps, which are periodically and repeatedly performed at a predetermined time interval:

(a) calculating and wirelessly transmitting the estimated reproduction time information TT1 and controlling the time for reproducing and outputting the video of the video data based on the estimated reproduction time difference information At received wirelessly, which are performed by the video reproduction apparatus, and

(b) calculating and wirelessly transmitting the estimated reproduction time information TT2 and controlling the time for reproducing and outputting the audio of the audio data based on the estimated reproduction time difference information Δt received wirelessly, which are performed by the audio reproduction apparatus.

Further, in the above-mentioned synchronous reproduction method, the video data is compression-coded video data, the video reproduction apparatus decompression-decodes wirelessly received video data, and the data processing time t1 includes a time required for the decompression-decoding. The audio data is compression-coded audio data, the audio reproduction apparatus decompression-decodes wirelessly received audio data, and the data processing time t2 includes a time required for the decompression-decoding.

### EFFECTS OF THE INVENTION

Therefore, according to the above-mentioned wireless communication system and the synchronous reproduction method of the present invention, in the wireless communication system including the server apparatus for transmitting moving image data, the display for reproducing and outputting video data, and the loudspeaker for reproducing and outputting audio data, synchronous reproduction of video data and audio data can be performed with precision higher than that of the prior art.

### BRIEF DESCRIPTION OF THE DRAWINGS

FIG. 1 is a block diagram showing a configuration of a wireless communication system according to one embodiment of the present invention;

FIG. 2 is a block diagram showing a configuration of a packet signal transmitted and received in the wireless communication system shown in FIG. 1;

FIG. 3 is a flow chart showing a synchronous reproduction and output control processing executed by an audio reproduction apparatus 110 and a video reproduction apparatus 120 shown in FIG. 1;

FIG. 4 is a sequence diagram showing the synchronous reproduction and output control processing executed by the wireless communication system shown in FIG. 1; and

FIG. 5 is a sequence diagram showing a synchronous reproduction and output control processing executed by a wireless communication system according to a modified preferred embodiment of the present invention.

### DESCRIPTION OF THE REFERENCE NUMERALS AND SYMBOLS

100 . . . Server apparatus,

101, 111, and 121 . . . Radio transceiver circuit,

101A, 111A, and 121A . . . Antenna,

102, 112, and 122 . . . System controller,

103, 113, and 123 . . . Buffer memory,

104 . . . Moving image data memory,

110 . . . Audio reproduction apparatus,

114 . . . Audio decoder,

115 and 125 . . . D/A converter,

116 . . . Loudspeaker,

117 and 127 . . . Decoder controller,

120 . . . Video reproduction apparatus,

124 . . . Video decoder,

126 . . . Display,

301 . . . Video data parameter information,

302 . . . Audio data parameter information,

303 . . . Video data packet,

304 . . . Audio data packet,

311 . . . Time stamp information,

312 . . . Key frame information,

313 . . . Compression-coded video data,

321 . . . Time stamp information, and

322 . . . Compression-coded audio data.

### BEST MODE FOR CARRYING OUT THE INVENTION

Embodiments according to the present invention will be described below with reference to the drawings. In addition, the same reference numerals and symbols are given to similar components.

### Embodiments

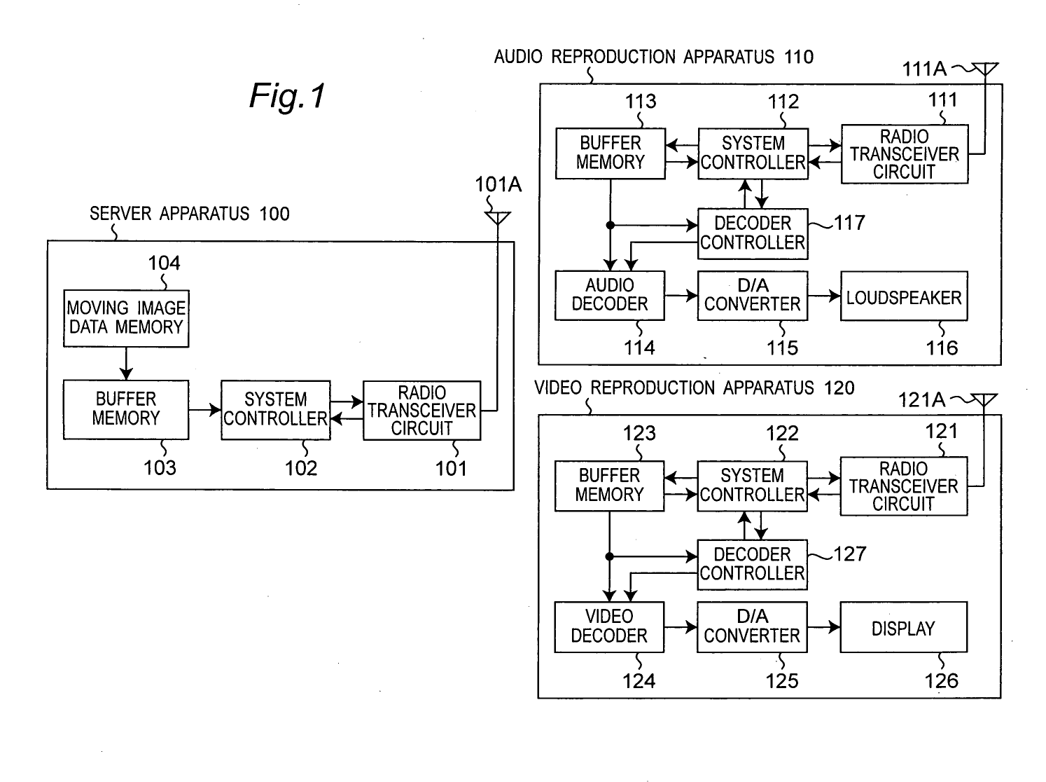

FIG. 1 is a block diagram showing a configuration of a wireless communication system according to one embodiment of the present invention. The wireless communication system according to the present embodiment is applied to a wireless video and audio reproduction system; as shown in FIG. 1, the wireless communication system includes, for example, a server apparatus 100 such as a DVD recorder or a personal computer, an audio reproduction apparatus 110, and a video reproduction apparatus 120, which are connected via a wireless network such as a wireless LAN.

Referring to FIG. 1, the server apparatus 100 includes a radio transceiver circuit 101 to which an antenna 101A is connected, a system controller 102, a buffer memory 103, and a moving image data memory 104, for example, a hard disk drive or the like. Further, the audio reproduction apparatus 110 includes a radio transceiver circuit 111 to which an antenna 111A is connected, a system controller 112, a buffer memory 113, an audio decoder 114, a digital to analog converter (referred to as a D/A converter hereinafter) 115, a loudspeaker 116, and a decoder controller 117. In this case, the system controller 112 controls operation of other circuit elements 111 to 115 of the audio reproduction apparatus 110. Further, the video reproduction apparatus 120 includes a radio transceiver circuit 121 to which an antenna 121A is connected, a system controller 122, a buffer memory 123, a video decoder 124, a D/A converter 125, a display 126, and a decoder controller 127. In this case, the system controller 122 controls operation of other circuit elements 121 to 125 of the video reproduction apparatus 120.

In the server apparatus 100, moving image data (for example, including a plurality of program data, each program data including video data and audio data) preliminarily stored in the moving image data memory 104 by user operation is inputted to the radio transceiver circuit 101 having a wireless communication function complying with, for example, Bluetooth and the wireless network standard such as a wireless LAN; the radio transceiver circuit 101 digitally modulates a radio carrier wave to a radio signal using a predetermined digital modulation system in accordance with the inputted moving image data, and then transmits to the same radio signal the audio reproduction apparatus 110 and the video reproduction apparatus 120 using the antenna 101A. In this case, while the moving image data recorded in the moving image data memory 104 is, for example, compression-coded video and audio data (moving image data formed in compliance with MPEG (Moving Picture Expert Group) system, for example), the present invention is not limited to this and data coded by other system may be used.

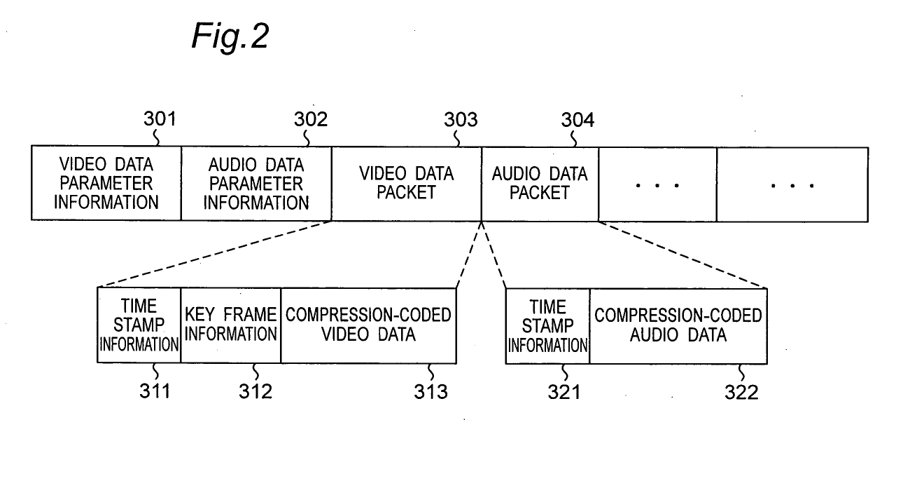

FIG. 2 is a block diagram showing a configuration of a packet signal transmitted and received by the wireless communication system shown in FIG. 1. In addition, the information (information such as an originator address and a destination address) for transmitting and receiving through the wireless network is added to a front column of the aforementioned one packet signal. As shown in FIG. 2, the aforementioned packet signal includes video data parameter information 301 having an ID on video data, a compression-coded system, and specification information relating thereto; audio data parameter information 302 having an ID on audio data, a compression-coded system, and specification information relating thereto; a video data packet 303; an audio data packet 304; and the subsequent video data packet 303 and audio data packet 304. In this case, the video data packet 303 includes time stamp information 311 which is obtained by counting a first time of one program as 0 hour 0 minute 0 second and which is time information of a first data of the aforementioned compression-coded video data 313; key frame information 312 which is frame information of I-picture upon compression-coded by MPEG method, for example; and compression-coded video data (video contents data) 313. Furthermore, the audio data packet 304 includes time stamp information 321 which is obtained by counting a first time of one program as 0 hour 0 minute 0 second and which is time information of a first data of the aforementioned compression-coded audio data 322, and compression-coded audio data (audio contents data) 322. That is, as shown in FIG. 2, the compression-coded video data and audio data include the time stamp information for setting reproduction time.

Referring to FIG. 1, the audio reproduction apparatus 110 receives a radio signal using the antenna 111A, where the radio signal includes the moving image data transmitted wirelessly from the server apparatus 100, and the audio reproduction apparatus 110 outputs the same radio signal to the radio transceiver circuit 111. The radio transceiver circuit 111 has a radio transceiver function similar to that of the radio transceiver circuit 101, receives the inputted radio signal and demodulates the received radio signal to moving image data using a digital demodulation system which is reverse of the above mentioned digital modulation system, and then stores the same moving image data temporarily in the buffer memory 113 via the system controller 112. After that, the audio decoder 114 extracts compression-coded audio data from the moving image data stored in the buffer memory 113, converts the compression-coded audio data into decompression-coded audio data by performing decompression and decoding processing, and then, outputs the decompression-coded audio data to the D/A converter 115. The D/A converter 115 converts the inputted audio data into analog audio signal, and then, outputs the analog audio signal to the loudspeaker 116 to reproduce as audio sound.

Furthermore, the video reproduction apparatus 120 receives a radio signal using the antenna 121A, where the radio signal includes the moving image data transmitted wirelessly from the server apparatus 100, and the video reproduction apparatus 120 outputs the same radio signal to the radio transceiver circuit 121. The radio transceiver circuit 121 has a radio transceiver function similar to that of the radio transceiver circuit 101, receives and demodulates the inputted radio signal to moving image data using a digital demodulation system which is reverse of the above mentioned digital modulation system, and then stores the same moving image data temporarily in the buffer memory 123 via the system controller 122. After that, the video decoder 124 extracts compression-coded video data from the moving image data stored in the buffer memory 123, converts the compression-coded data into decompression-coded video data by performing decompression and decoding processing, and then, outputs the decompression-coded video data to the D/A converter 125. The D/A converter 125 converts the inputted video data into analog video signal, and then, outputs the analog video signal to the display 126 to display thereon by reproducing video of the aforementioned video data.

In this case, the buffer memory 113 and 123 have such a function of storing data so that reproduction of video and audio is not interrupted by a transmission error in wireless communication. On the other hand, since data to be reproduced in each of the buffer memories 113 and 123 is stored, there is such a problem that the moving image data transmitted from the server apparatus 100 does not always output audio and video at the same time from the loudspeaker 116 and the display 126. In order to solve the problem, the wireless communication system according to the present embodiment executes the following synchronous reproduction and output control processing.

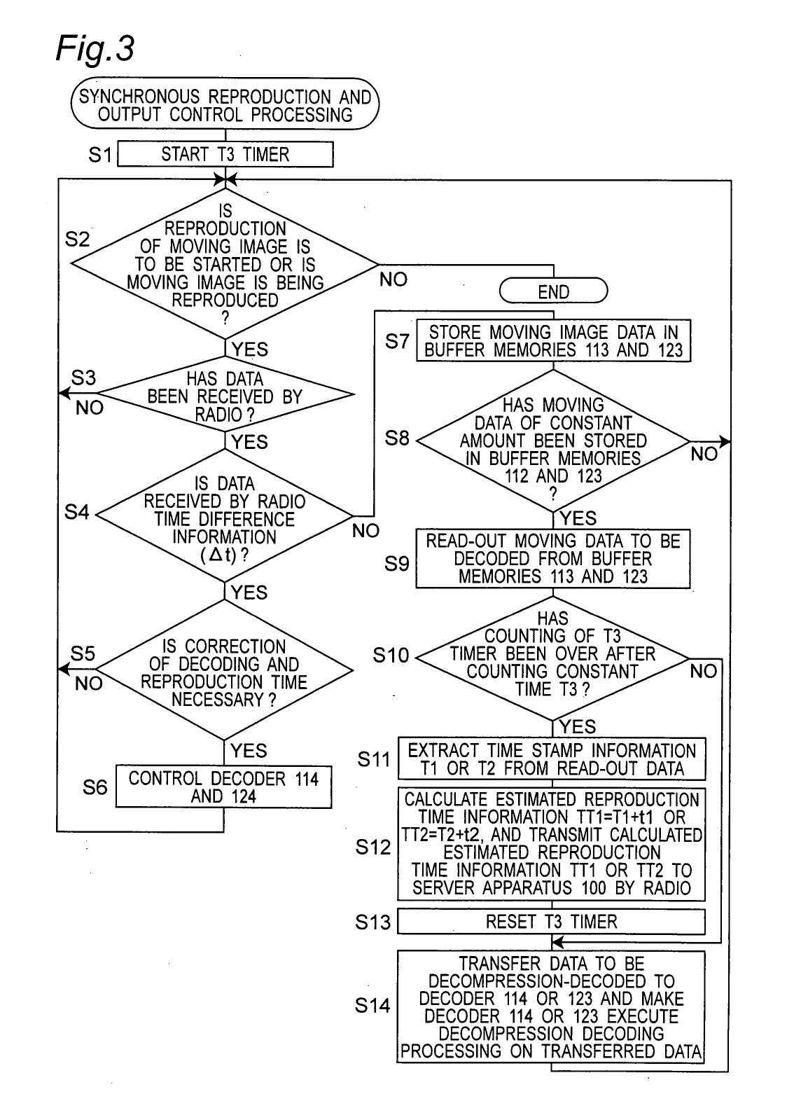

FIG. 3 is a flow chart showing a synchronous reproduction and output control processing executed by the audio reproduction apparatus 110 and the video reproduction apparatus 120 shown in FIG. 1.

Referring to FIG. 3, first of all, in step S1, the process starts counting by a T3 timer for counting the time T3 (as shown by a process denoted by NO in step S10 of FIG. 3, the T3 timer is provided for controlling the same apparatuses so that correction of reproduction time in decoding is not required, and decoding is performed instantaneously for a predetermined time T3). In step S2, it is determined whether or not reproduction of moving image is to be started or the moving image is being reproduced, and if YES, the process proceeds to step S3; whereas if NO, the aforementioned synchronous reproduction and output control processing is ended. In step S3, it is determined whether or not data is received wirelessly, and if YES, the process proceeds to step S4; whereas if NO, the process returns to step S2. After that, in step S4, it is determined whether or not data received wirelessly is time difference information (Δt), and if YES, the process proceeds to step S5; whereas if NO, that is, if it is the moving image data, the process proceeds to step S7. In step S5, it is determined whether or not correction of decoding and reproduction time is necessary based on the time difference information (Δt). In this case, for example, if it is |Δt|>100 milliseconds, a user determines that it can be recognized as a remarkable time difference between video and audio; and in step S6, the decoder 114 and 124 are controlled based on the received time difference information (Δt) to delay the reproduction time of each data and then the process returns to step S2. On the other hand, if NO in step S5, the process of step S6 is not executed, and the process returns to step S2.

In step S7, the moving image data is stored in the buffer memories 113 and 123. In step S8, it is determined whether or not a constant amount of moving image data, for example, 10 MB, has been stored in the buffer memories 113 and 123, and if YES, the process proceeds to step S9; whereas if NO, the process returns to step S2. After that, in step S9, the moving image data to be decoded is read out from the buffer memories 113 and 123. In step S10, it is determined whether or not the T3 timer has been over after counting by a constant time T3, and if YES, the process proceeds to step S11; whereas if NO, the process proceeds to step S14. In step S11, time stamp information T1 or T2 is extracted from read out data. In step S12, estimated reproduction time information TT1=T1+t1 or TT2=T2+t2 is calculated, and the calculated estimated reproduction time information TT1 or TT2 is transmitted wirelessly to the server apparatus 100.

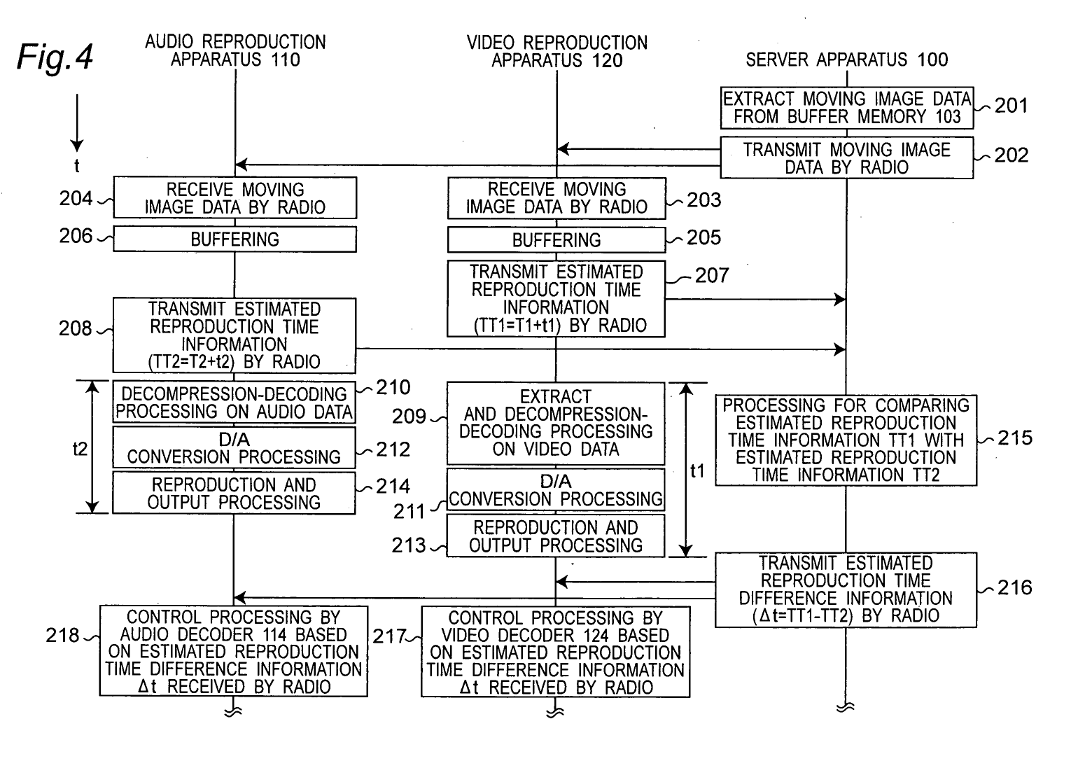

In this case, as shown in FIG. 4, with respect to a predetermined amount of compression-coded video data, t1 is a known data processing time capable of previously determining depending on the apparatus, required for from extract and decompression-decoding processing on video data by the video decoder 124 to reproduction and output processing by the display 126 via D/A conversion processing by the D/A converter 125. Furthermore, as shown in FIG. 4, with respect to a predetermined amount of compression-coded audio data, t2 is a known data processing time capable of previously determining depending on the apparatus, required for from extract and decompression-decoding processing on audio data by the audio decoder 114 to reproduction and output processing by the loudspeaker 116 via D/A conversion processing by the D/A converter 125. In this case, the known data processing time t1 and t2 are substantially constant regardless of an ambient electric wave environment, temperature, humidity, and the like.

Then, in step S13, the process proceeds to step S14 by resetting the T3 timer. In step S14, data to be decompression-decoded is transferred to the decoder 114 or 124, which then executes decompression-decoding processing; and then, the process returns to step S2.

FIG. 4 is a sequence diagram showing the synchronous reproduction and output control processing executed by the wireless communication system shown in FIG. 1. The synchronous reproduction and output control processing for synchronously reproducing video and audio will be described below with reference to FIG. 4.

(1) First of all, the server apparatus 100 extracts moving image data to be reproduced (in step 201) and transmits the moving image data wirelessly to the audio reproduction apparatus 110 and the video reproduction apparatus 120 (in step 202).

(2) The audio reproduction apparatus 110 wirelessly receives the moving image data transmitted wirelessly from the server apparatus 100 (in step 204) and stores the moving image data in the buffer memory 113 (in step 206). Furthermore, the video reproduction apparatus 120 also wirelessly receives the moving image data transmitted wirelessly from the server apparatus 100 (in step 203) and stores the moving image data in the buffer memory 123 (in step 205).

(3A) The audio decoder 114 of the audio reproduction apparatus 110 extracts the compression-coded audio data from the moving image data stored in the buffer memory 113 and performs decompression-decoding processing on the aforementioned compression-coded audio data, and then, informs the decoder controller 117 of time stamp information T2 contained in the audio data for performing the aforementioned decompression-decoding processing. The decoder controller 117 calculates the estimated reproduction time information TT2=T2+t2 by adding the known data processing time t2 to the informed time stamp information T2, where the known data processing time t2 is the time required when the compression-coded audio data is read out from the buffer memory 113 and is outputted through the loudspeaker 116 after performing the extract and decompression-decoding processing and the D/A conversion processing. Then the decoder controller 117 transmits the calculated estimated reproduction time information TT2 wirelessly to the server apparatus 100 via the system controller 112 and the radio transceiver circuit 111 (in step 208). After performing the aforementioned wireless transmission, the process executes the extract and decompression-decoding processing on audio data, the D/A conversion processing, and the reproduction and output processing on the above-mentioned read out audio data (in steps 210, 212, and 214).

(3B) The video decoder 124 of the video reproduction apparatus 120 extracts the compression-coded video data from the moving image data stored in the buffer memory 123 and perform decompression-decoding processing on the aforementioned compression-coded video data, and then informs the decoder controller 127 of time stamp information T1 contained in the video data for performing the aforementioned decompression-decoding processing. The decoder controller 127 calculates the estimated reproduction time information TT1=T1+t1 by adding the known data processing time t1 to the informed time stamp information T1, where the known data processing time t1 is the time required when the compression-coded video data is read out from the buffer memory 123 and is outputted to display the same video data on the display 126 after performing the extract and decompression-decoding processing and the D/A conversion processing. The decoder controller 127 transmits the calculated estimated reproduction time information TT1 wirelessly to the server apparatus 100 via the system controller 122 and the radio transceiver circuit 121 (in step 207). After performing the aforementioned wireless transmission, the process executes the extract and decompression-decoding processing on video data, the D/A conversion processing, and the reproduction and output processing on the above-mentioned read out video data (in steps 209, 211, and 213).

(4) The radio transceiver circuit 101 of the server apparatus 100 receives the estimated reproduction time information TT1 and TT2 transmitted from the audio reproduction apparatus 110 and the video reproduction apparatus 120, compares the estimated reproduction time information TT1 of the video data with the estimated reproduction time information TT2 of the audio data to calculate estimated reproduction time difference information Δt=TT1−TT2 (in step 215), and transmits the calculated estimated reproduction time difference information Δt (for example, if it is Δt=100 milliseconds, this means that output of the video data delays by 100 milliseconds ) wirelessly to the audio reproduction apparatus 120 and the audio reproduction apparatus 110 (in step 216).

(5) The decoder controller 117 controls the audio decoder 114 so that the system controller 112 of the audio reproduction apparatus 110 reduces time difference in response to the estimated reproduction time difference information Δt received wirelessly (in step 218). On the other hand, the decoder controller 127 controls the video decoder 124 so that the system controller 122 of the video reproduction apparatus 120 also reduces time difference in response to the estimated reproduction time difference information Δt received wirelessly (in step 217). The decoder controllers 117 and 127 are respectively corrected so that operation clock of the audio decoder 114 and the video decoder 124 are made fast by approximately several ppm and are controlled by omitting data decoding of several packets, and this leads to that the production time can be quickened. In the contrary, the reproduction time can be delayed by correcting so that the operation clock of the audio decoder 114 and the video decoder 124 are made slow by approximately several ppm.

As described above, according to the embodiment of the present invention, when the moving image data transmitted and received using a wireless communication system is reproduced, reproduction of video data and audio data can be easily substantially synchronized. Furthermore, the transmitting and receiving of the estimated reproduction time information and the estimated reproduction time difference information and control processing of the audio decoder 114 and the video decoder 124 are periodically and repeatedly performed at a constant time interval using the above mentioned T3 timer, for example, and this leads to that synchronous reproduction coping with change in an ambient electric wave environment anytime can be achieved.

Furthermore, the embodiment according to the present invention can be applied to, for example, a wireless communication system having two audios at right and left like a home theater or having further multiple loudspeakers for reproducing, and a wireless communication system having a plurality of displays.

Further, since the embodiment according to the present invention can control reproduction time of video data and audio data, in the case of a wireless communication system including a plurality of loudspeakers, it is possible to make a surround effect alive by intentionally delaying time reproduced from the respective loudspeakers.

Still further, in the embodiment according to the present invention, data transmitted and received using a wireless communication system is described as moving image data including video data and audio data. However, the present invention is not limited to this and is not limited to moving image data, and it can be applied to an audio system or the like which does not need video output like a mini-component or the like, and a radio receiver.

### Modified Preferred Embodiment

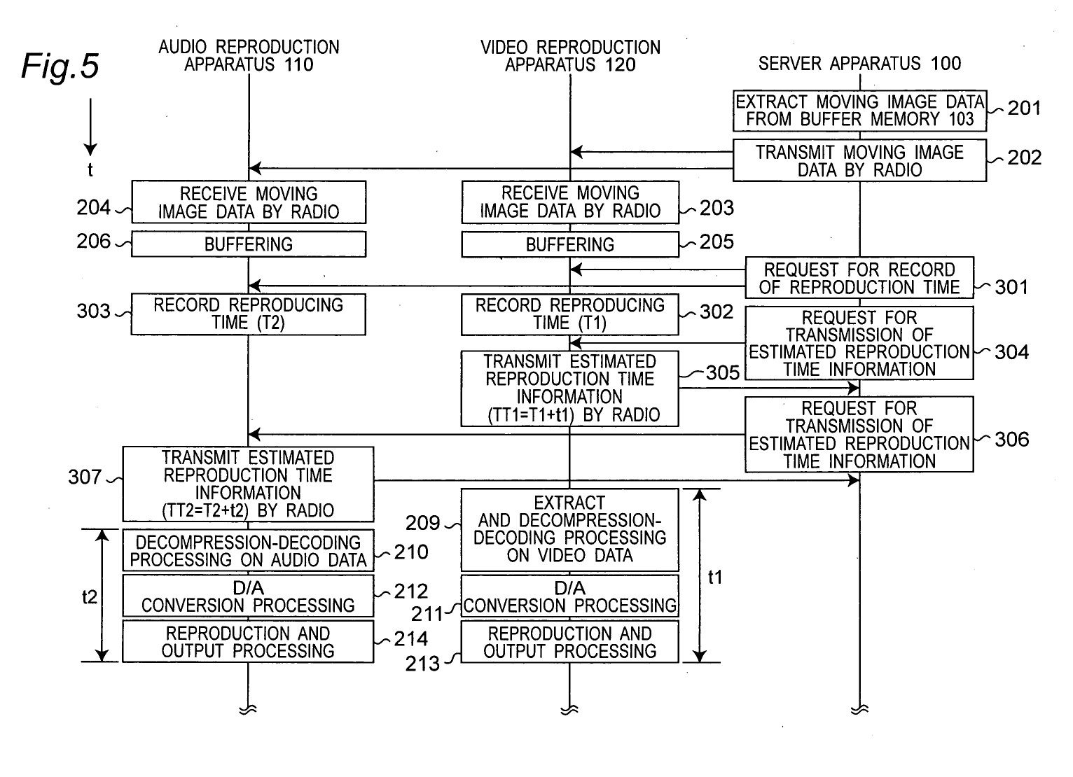

FIG. 5 is a sequence diagram showing a synchronous reproduction and output control processing executed by a wireless communication system according to a modified preferred embodiment of the present invention. It is characterized in that the modified preferred embodiment is different in the following points, as compared with the above-mentioned embodiment.

(1) A server apparatus 100 transmits a request for record of reproduction time by broadcast to an audio reproduction apparatus 110 and a video reproduction apparatus 120 at a predetermined time interval. Furthermore, upon receiving the request for record of reproduction time from the server apparatus 100, the audio reproduction apparatus 110 and the video reproduction apparatus 120 calculate estimated reproduction time information TT1 and TT2, respectively.

(2) The server apparatus 100 respectively transmits a request for transmission of estimated reproduction time information wirelessly to the audio reproduction apparatus 110 and the video reproduction apparatus 120 at a predetermined time interval. Furthermore, upon receiving the request for transmission of estimated reproduction time information from the server apparatus 100, the audio reproduction apparatus 110 and the video reproduction apparatus 120 transmit the calculated estimated reproduction time information TT1 and TT2 wirelessly to the server apparatus 100, respectively.

In this case, the server apparatus 100 wirelessly transmits the request for record of reproduction time, the request for transmission of estimated reproduction time information to the audio reproduction apparatus 110, and the request for transmission of estimated reproduction time information to the video reproduction apparatus 120, for example, for ten-second interval, respectively.

The sequence of the modified preferred embodiment replaces (3A) and (3B) of the sequence in the embodiment by the following (3C), (3C1), (3C2), (3D), (3D1), (3E), and (3E1). The different points will be described in detail below.

(3C) The server apparatus 100 transmits the request for record of reproduction time wirelessly to the audio reproduction apparatus 110 and the video reproduction apparatus 120 (in step 301).

(3C1) The video decoder 124 of the video reproduction apparatus 120 extracts compression-coded video data from moving image data stored in the buffer memory 123 and performs decompression-decoding processing on the aforementioned compression-coded video data, and then, informs the decoder controller 127 of time stamp information T1 contained in the video data for performing the aforementioned decompression-decoding processing. The system controller 122 receives the request for record of reproduction time transmitted wirelessly from the server apparatus 100 via an antenna 121A and a radio transceiver circuit 121, and transmits a command for directing calculation of the estimated reproduction time information TT1 to the decoder controller 127. Upon receiving the command for directing calculation of the estimated reproduction time information TT1, the decoder controller 127 calculates the estimated reproduction time information TT1=T1+t1 by adding the known data processing time t1 to the time stamp information T1 informed from the video decoder 124, where the known data processing time t1 is the time required when the compression-coded video data is read out from the buffer memory 123 and outputted to display the same video data on the display 126 after performing extract and decompression-decoding processing and D/A conversion processing. The decoder controller 127 records the same estimated reproduction time information TT1 in a temporary memory of the video reproduction apparatus 120 (in step 302).

(3C2) The audio decoder 114 of the audio reproduction apparatus 110 extracts compression-coded audio data from moving image data stored in the buffer memory 113 and performs decompression-decoding processing on the aforementioned compression-coded audio data, and then, informs the decoder controller 117 of time stamp information T2 contained in the audio data for performing the aforementioned decompression-decoding processing. The system controller 112 receives the request for record of reproduction time transmitted wirelessly from the server apparatus 100 via an antenna 111A and the radio transceiver circuit 111, and transmits a command for directing calculation of the estimated reproduction time information TT2 to the decoder controller 117. Upon receiving the command for directing calculation of the estimated reproduction time information TT2, the decoder controller 117 calculates the estimated reproduction time information TT2=T2+t2 by adding the known data processing time t2 to the time stamp information T2 informed from the audio decoder 114, where the known data processing time t2 is the time required when the compression-coded audio data is read out from the buffer memory 113 and is outputted through the loudspeaker 116 after performing extract and decompression-decoding processing and D/A conversion processing. The decoder controller 117 records the same audio data in the temporary memory of the audio reproduction apparatus 110 (in step 303).

(3D) Next, the server apparatus 100 transmits the request for transmission of estimated reproduction time information wirelessly to the video reproduction apparatus 120 (in step 304).

(3D1) The system controller 122 of the video reproduction apparatus 120 receives the request for transmission of estimated reproduction time information transmitted wirelessly from the server apparatus 100 via the antenna 121A and the radio transceiver circuit 121, and transmits the transmission command of the estimated reproduction time information TT1 to the decoder controller 127. The decoder controller 127 transmits the calculated estimated reproduction time information TT1 wirelessly to the server apparatus 100 via the system controller 122 and the radio transceiver circuit 121 (in step 305). After performing the aforementioned transmission wirelessly, the process executes the extract and decompression-decoding processing on video data, the D/A conversion processing, and the reproduction and output processing on the above-mentioned read out video data (in steps 209, 211, and 213).

(3E) Next, the server apparatus 100 transmits the request for transmission of estimated reproduction time information wirelessly to the audio reproduction apparatus 110 (in step 306).

(3E1) The system controller 112 of the audio reproduction apparatus 110 receives the request for transmission of estimated reproduction time information transmitted wirelessly from the server apparatus 100 via the antenna 111A and the radio transceiver circuit 111, and transmits the transmission command of the estimated reproduction time information TT2 to the decoder controller 117. The decoder controller 117 transmits the calculated estimated reproduction time information TT2 wirelessly to the server apparatus 100 via the system controller 112 and the radio transceiver circuit 111 (in step 208). After performing the aforementioned wireless transmission, the process executes the extract and decompression-decoding processing on audio data, the D/A conversion processing, and the reproduction and output processing on the above-mentioned read out audio data (in steps 210, 212, and 214).

In the above-mentioned modified preferred embodiment, the server apparatus 100 transmits the request for record of reproduction time by broadcast to the audio reproduction apparatus 110 and the video reproduction apparatus 120. However, the present invention is not limited to this, and the server apparatus 100 may transmit the request for record of reproduction time by the unicast to the audio reproduction apparatus 110 and the video reproduction apparatus 120. In this case, the server apparatus 100 records the time differences when transmitting the request for record of reproduction time wirelessly to each apparatus, and adds or reduces each time difference to or from the estimated reproduction time difference information At.

### INDUSTRIAL APPLICABILITY

As described above, according to the wireless communication system and the synchronous reproduction method according to the present invention, in the wireless communication system including the server apparatus for transmitting moving image data, the display for reproducing and outputting video data, and the loudspeaker for reproducing and outputting audio data, synchronous reproduction of video data and audio data can be performed with precision higher than that of the prior art.

1. A wireless communication system comprising:
a server apparatus for wirelessly transmitting video data with time data and audio data with time data, respectively;
a video reproduction apparatus for wirelessly receiving the video data with the time data transmitted wirelessly from the server apparatus, and reproducing and outputting video of the video data; and
an audio reproduction apparatus for wirelessly receiving the audio data with the time data transmitted wirelessly from the server apparatus, and reproducing and outputting audio of the audio data,
wherein, upon reproducing and outputting the video of the video data, the video reproduction apparatus calculates estimated reproduction time information TT1 by adding a known data processing time t1 required for reproducing and outputting the video data is added to time data T1 of the video data, and wirelessly transmits the estimated reproduction time information TT1 to the server apparatus;
wherein, upon reproducing and outputting the audio of the audio data, the audio reproduction apparatus calculates estimated reproduction time information TT2 by adding a known data processing time t2 required for reproducing and outputting the audio data to time data T2 of the audio data, and wirelessly transmits the estimated reproduction time information TT2 to the server apparatus;
wherein the server apparatus wirelessly receives the estimated reproduction time information TT1 from the video reproduction apparatus, wirelessly receives the estimated reproduction time information TT2 from the audio reproduction apparatus, then calculates estimated reproduction time difference information Δt between the estimated reproduction time information TT1 and the estimated reproduction time information TT2, and wirelessly transmits the estimated reproduction time difference information Δt to the video reproduction apparatus and the audio reproduction apparatus;
wherein the video reproduction apparatus wirelessly receives the estimated reproduction time difference information Δt from the server apparatus, and then controls a time for reproducing and outputting the video data so that the video of the video data to be reproduced and outputted from the video reproduction apparatus and the audio of the audio data to be reproduced and outputted from the audio reproduction apparatus are substantially synchronously reproduced and outputted based on the estimated reproduction time difference information Δt received wirelessly; and
wherein the audio reproduction apparatus wirelessly receives the estimated reproduction time difference information Δt from the server apparatus, and then controls a time for reproducing and outputting the audio data so that the audio of the audio data to be reproduced and outputted from the audio reproduction apparatus and the video of the video data to be reproduced and outputted from the video reproduction apparatus are substantially synchronously reproduced and outputted based on the estimated reproduction time difference information Δt received wirelessly.

2. The wireless communication system as claimed in claim 1,
wherein the following steps are periodically and repeatedly performed at a predetermined time interval:
(a) calculating and wirelessly transmitting the estimated reproduction time information TT1 and controlling the time for reproducing and outputting the video of the video data based on the estimated reproduction time difference information Δt received wirelessly, which are performed by the video reproduction apparatus, and
(b) calculating and wirelessly transmitting the estimated reproduction time information TT2 and controlling the time for reproducing and outputting the video of the audio data based on the estimated reproduction time difference information Δt received wirelessly, which are performed by the audio reproduction apparatus.

3. The wireless communication system as claimed in claim 1,
wherein the video data is compression-coded video data, the video reproduction apparatus decompression-decodes wirelessly received video data, and the data processing time t1 includes a time required for the decompression-decoding; and
wherein the audio data is compression-coded audio data, the audio reproduction apparatus decompression-decodes wirelessly received audio data, and the data processing time t2 includes a time required for the decompression-decoding.

4. A synchronous reproduction method using a wireless communication system, the wireless communication system comprising:
a server apparatus for wirelessly transmitting video data with time data and audio data with time data, respectively;
a video reproduction apparatus for wirelessly receiving the video data with time data transmitted wirelessly from the server apparatus, and reproducing and outputting output video of the video data; and
an audio reproduction apparatus for wirelessly receiving the audio data with time data transmitted wirelessly from the server apparatus, and reproducing and outputting audio of the audio data,
wherein the synchronous reproduction method includes the following steps:
upon the video reproduction apparatus's reproducing and outputting the video of the video data, calculating estimated reproduction time information TT1 by adding a known data processing time t1 required for reproducing and outputting the video data to time data T1 of the video data, and wirelessly transmitting the estimated reproduction time information TT1 to the server apparatus;
upon the audio reproduction apparatus's reproducing and outputting the audio of the audio data, calculating estimated reproduction time information TT2 by adding a known data processing time t2 required for reproducing and outputting the audio data to time data T2 of the audio data, and wirelessly transmitting the estimated reproduction time information TT2 to the server apparatus;
in the server apparatus, wirelessly receiving the estimated reproduction time information TT1 from the video reproduction apparatus, wirelessly receiving the estimated reproduction time information TT2 from the audio reproduction apparatus, then calculating estimated reproduction time difference information Δt between the estimated reproduction time information TT1 and the estimated reproduction time information TT2, and wirelessly transmitting the estimated reproduction time difference information Δt to the video reproduction apparatus and the audio reproduction apparatus;
in the video reproduction apparatus, wirelessly receiving the estimated reproduction time difference information Δt from the server apparatus, and then controlling a time for reproducing and outputting the video data so that the video of the video data to be reproduced and outputted from the video reproduction apparatus and the audio of the audio data to be reproduced and outputted from the audio reproduction apparatus are substantially synchronously reproduced and outputted based on the estimated reproduction time difference information Δt received wirelessly; and
in the audio reproduction apparatus, wirelessly receiving the estimated reproduction time difference information Δt from the server apparatus, and then controlling a time for reproducing and outputting the audio data so that the audio of the audio data to be reproduced and outputted from the audio reproduction apparatus and the video of the video data to be reproduced and outputted from the video reproduction apparatus are substantially synchronously reproduced and outputted based on the estimated reproduction time difference information Δt received wirelessly.

5. The synchronous reproduction method as claimed in claim 4, further including the following steps, which are periodically and repeatedly performed at a predetermined time interval:
(a) calculating and wirelessly transmitting the estimated reproduction time information TT1 and controlling the time for reproducing and outputting the video of the video data based on the estimated reproduction time difference information Δt received wirelessly, which are performed by the video reproduction apparatus, and
(b) calculating and wirelessly transmitting the estimated reproduction time information TT2 and controlling the time for reproducing and outputting the video of the audio data based on the estimated reproduction time difference information Δt received wirelessly, which are performed by the audio reproduction apparatus.

6. The synchronous reproduction method as claimed in claim 4,
wherein the video data is compression-coded video data, the video reproduction apparatus decompression-decodes wirelessly received video data, and the data processing time t1 includes a time required for the decompression-decoding; and
wherein the audio data is compression-coded audio data, the audio reproduction apparatus decompression-decodes wirelessly received audio data, and the data processing time t2 includes a time required for the decompression-decoding.
